(19) United States
(12) Patent Application Publication
(10) Pub. No.: US 2025/0058744 A1
(43) Pub. Date: Feb. 20, 2025

(54) Rechargeable Vehicle Key Fob Device

(71) Applicant: Christopher Holland, St. Louis, MO (US)

(72) Inventor: Christopher Holland, St. Louis, MO (US)

(21) Appl. No.: 18/794,142

(22) Filed: Aug. 5, 2024

Related U.S. Application Data
(60) Provisional application No. 63/519,441, filed on Aug. 14, 2023.

(51) Int. Cl. B60R 25/40; B60R 25/22; B60R 25/24

(52) U.S. Cl. CPC B60R 25/406; B60R 25/22; B60R 25/24; B60R 2325/103

(57) ABSTRACT

A rechargeable key fob device for controlling a vehicle. The key fob device features an integrated rechargeable Lithium-ion (Li-ion) battery to power the key fob's functions, including the operation of buttons and LED indicators. An internal memory stores unique identification codes associated with specific vehicles and facilitates firmware or software updates for the key fob. The key fob includes a cavity for storing a key which can be automatically pulled out upon pressing a push button positioned on a panel of the key fob. A torsional spring rotates to pull out and retract the key. A charging port receives a charging cord for recharging the battery, eliminating the requirement of replacing a key fob battery.

### CROSS-REFERENCE TO RELATED APPLICATION

The present application claims priority to, and the benefit of, U.S. Provisional Application No. 63/519,441, which was filed on Aug. 14, 2023 and is incorporated herein by reference in its entirety.

### FIELD OF THE INVENTION

The present invention relates generally to the field of key fobs. More specifically, the present invention relates to a novel rechargeable key fob for vehicles which features a rechargeable battery and a charging port. A cavity of the key fob stores a vehicle key and a push button pulls out and retracts the key. Accordingly, the present disclosure makes specific reference thereto. Nonetheless, it is to be appreciated that aspects of the present invention are also equally applicable to others like applications, devices, and methods of manufacture.

### BACKGROUND

By way of background, key fobs are widely used as a convenient means to lock and unlock vehicles and control other features of vehicles from a short distance. However, with extended use of a key fob over time, the battery within the key fob eventually depletes and requires replacement. A depleting battery charge can be a frustrating experience for vehicle owners, as they become unable to lock or unlock their vehicles without a functional key fob. Further, replacing the battery of a key fob is time consuming and expensive.

Another issue with conventional key fobs is the lack of a battery level indication for users. Without a clear indication of the battery's remaining power, owners cannot know about approaching depletion of battery power. Furthermore, a typical key fob design often has the vehicle key continuously extended from it. The constant protrusion of the key from the key fob can lead to potential damage, both to the key and to other objects such as clothing of a user storing the key fob. People desire an improved key fob that can be recharged and that can store a key therein.

Therefore, there exists a long felt need in the art for an improved key fob design. There is also a long felt need in the art for a rechargeable key fob for vehicles. Additionally, there is a long felt need in the art for a vehicle key fob that includes a charging port for recharging a key fob's battery. Moreover, there is a long felt need in the art for a key fob that provides an indication of the key fob's battery level. Further, there is a long felt need in the art for a key fob that includes a storage space for accommodating a vehicle key. Finally, there is a long felt need in the art for a vehicle key fob that offers a way to keep key fobs fully charged and functional for the entire life of a vehicle.

The subject matter disclosed and claimed herein, in one embodiment thereof, comprises a rechargeable key fob for a vehicle. The key fob further comprising a sturdy body, the body having a first panel and a second opposing panel, a cavity disposed between the first and second panels, the cavity designed to accommodate a key of the vehicle, the first and second panels joined along one side edge of the body, a rechargeable battery housed within the key fob, and a charging port for recharging the battery, wherein the charging port receives a charging cord to receive electric current for recharging the battery. The key fob includes a plurality of buttons for controlling operations of a vehicle wherein LEDs disposed around the buttons illuminate in a first color to indicate low battery level and illuminate in a second to indicate charged battery level. A push button positioned in the body automatically pulls out and retracts a key inside the key fob.

In this manner, the rechargeable key fob of the present invention accomplishes all of the forgoing objectives and provides users with a rechargeable key fob for locking and unlocking vehicles. The key fob prevents the key fob from ever running out of battery, ensuring users can always wirelessly lock, unlock, and operate their vehicle. The battery of the key fob is rechargeable and can be recharged using the charging port.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a rechargeable key fob for a vehicle. The key fob further comprising a sturdy body, the body having a first panel and a second opposing panel, a cavity disposed between the first and second panels, the cavity designed to accommodate a key of the vehicle, the first and second panels joined along one side edge of the body, a rechargeable battery housed within the key fob, and a charging port for recharging the battery, wherein the charging port receives a charging cord to receive electric current for recharging the battery.

In a further embodiment of the present invention, an outer surface of the first panel has a vehicle lock button and a vehicle unlock button wherein each button is equipped with a peripheral LED that is activated upon pressing the corresponding button.

In a further embodiment of the present invention, a key fob system for a vehicle is disclosed. The key fob includes a first panel and a second opposing panel, a cavity located between the first and second panels, designed to accommodate a key of the vehicle, a key push button positioned on an outer surface of the first panel, a rotating torsional spring positioned across the panels within the cavity, the push button is coupled to the torsional spring, enabling automatic extraction of the key from the cavity when pressed by a user, wherein the torsional spring passes through the bow end of the key to allow rotation and manual operation of the vehicle using the key's blade portion.

In yet another embodiment, a rechargeable vehicle key fob device is disclosed. The key fob device includes an integrated Lithium-ion (Li-ion) battery, a wireless transceiver for establishing wireless communication with a vehicle, an internal memory used for storing unique identification codes associated with specific vehicles and firmware/software updates of the key fob, a charging port for recharging the battery, and a charging coupler coupling the charging port and the battery, enabling auto-cut or trickle charging to prevent battery overheating.

In a further embodiment, the peripheral LED lights illuminate in a first color when the battery level is 10% or less, indicating a low battery level and illuminate in a second color when the battery level is 98% or more, indicating a fully recharged battery.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of a rechargeable key fob of the present invention in accordance with the disclosed architecture;

FIG. 2 illustrates a rear perspective view of the rechargeable key fob device of the present invention in accordance with the disclosed architecture;

FIG. 3 illustrates a block diagram showing electronic components included in the rechargeable key fob of the present invention in accordance with the disclosed architecture;

FIG. 4 illustrates a perspective view showing the rechargeable key fob connected to a charging cord for recharging integrated battery in accordance with the disclosed architecture;

FIG. 5 illustrates a flow diagram depicting a process of using key fob and alerting a user of battery level in accordance with the disclosed architecture;

FIG. 6 illustrates a flow diagram depicting use of the key push button of the key fob device of the present invention in accordance with the disclosed architecture; and

FIG. 7 illustrates a schematic view showing use of the rechargeable key fob device used for communication with a vehicle in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an improved key fob design. There is also a long felt need in the art for a rechargeable key fob for vehicles. Additionally, there is a long felt need in the art for a vehicle key fob that includes a charging port for recharging a key fob's battery. Moreover, there is a long felt need in the art for a key fob that provides an indication of the key fob's battery level. Further, there is a long felt need in the art for a key fob that includes a storage space for accommodating a vehicle key Finally, there is a long felt need in the art for a vehicle key fob that offers a way to keep key fobs fully charged and functional for the entire life of a vehicle.

The present invention, in one exemplary embodiment, is a rechargeable vehicle key fob device. The key fob device includes an integrated Lithium-ion (Li-ion) battery, a wireless transceiver for establishing wireless communication with a vehicle, an internal memory used for storing unique identification codes associated with specific vehicles and firmware/software updates of the key fob, a charging port for recharging the battery, and a charging coupler coupling the charging port and the battery, enabling auto-cut or trickle charging to prevent battery overheating. The key fob also includes a cavity for storing a key and a push button for automatically extracting and retracting the key fob.

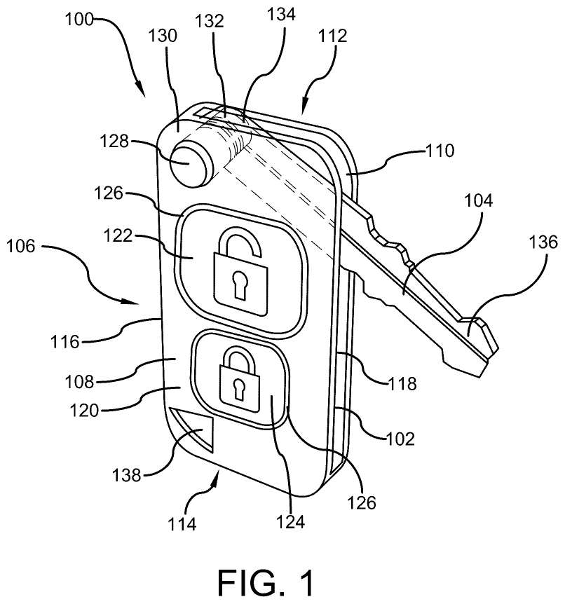

Referring initially to the drawings, FIG. 1 illustrates a front perspective view of a rechargeable key fob of the present invention in accordance with the disclosed architecture. The rechargeable key fob 100 of the present invention is a vehicle key fob that can be recharged, thereby eliminating the requirement of users to replace the battery of the key fob. Further, the rechargeable key fob 100 has a cavity 102 therein for accommodating a key 104 of a vehicle, thus, preventing the key 104 from physical damage. More specifically, the key fob 100 has a sturdy body 106 which can be of any geometric shape and can represent the shape of a vehicle for which the key fob 100 is designed.

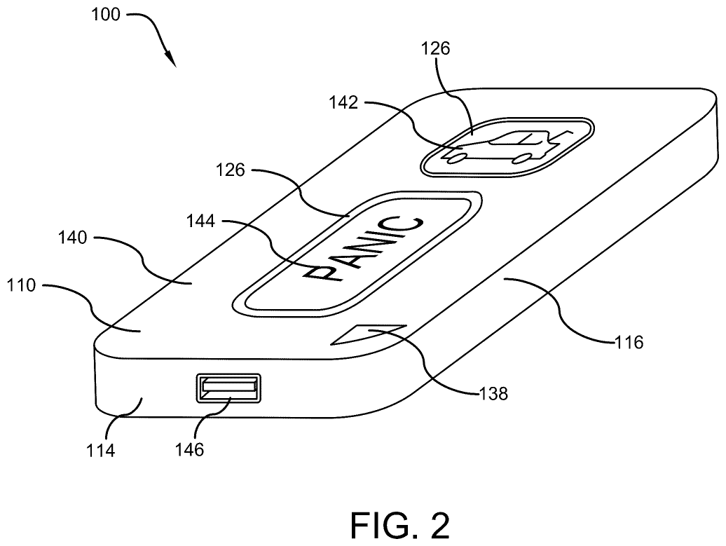

Referring to FIGS. 1 and 2, the rechargeable key fob 100 has a first panel 108 and a second opposing panel 110 with a cavity 102 disposed between them. The cavity 102 is designed to accommodate the key 104 and extends from first (top) lateral edge 112 to opposing (bottom) lateral edge 114 of the body 106. Further, the panels 108, 110 are joined or connected along one side edge 116 of the body 106 to form one-piece construction of the key fob device 100 and the cavity 102 is accessible along the opposing side edge 118 and the top edge 112 of the body 106. In the preferred embodiment, the cavity 102 has a width of about 75%-80% of a width of the body 102.

The outer surface 120 of the first panel 108 has a vehicle unlock button 122 and a vehicle lock button 124. The buttons 122, 124 can be touch buttons, push buttons, or any other kind of buttons for controlling a vehicle. In the preferred embodiment, each button 122, 124 can have a peripheral LED 126, which is activated upon pressing the corresponding button. In some embodiments, each button 122, 124 can have an embedded LED (not shown) for illumination when the button is pushed or activated by a user.

The front panel 108 has a key push button 128 position near the intersection 130 of the first lateral edge 112 and the side edge 116. The push button 128 is used for automatically pulling out (i.e., rotating the bow end) the key 104 from the cavity 102 when the push button 128 is pressed by a user. The push button 128 is coupled to a rotating torsional spring 132 which is positioned across the panels 108, 110 in the cavity 102. When the push button 128 is pressed, the torsional spring 132 rotates counterclockwise to pull the key 104 from the cavity 102 until the key 104 extends above the body 106 and becomes parallel to the side edges 116, 118. The torsional spring 132 passes through the bow end 134 of the key 104 for enabling the key 104 to rotate and enabling a user to use the blade portion 136 of the key 104 to manually operate a vehicle.

Referring again to FIGS. 1 and 2, the body 106 has an opening 138 across the panels 108, 110 for enabling a user to use a keychain, a loop, and the like for hanging the key fob device 100 for easy transportation and carriage.

FIG. 2 illustrates a rear perspective view of the rechargeable key fob device of the present invention in accordance with the disclosed architecture. The exterior surface 140 of the rear panel 110 has a trunk or rear liftgate unlock button 142 for automatically unlocking the trunk/liftgate and a Panic button 144 for enabling a user to activate built-in sensors and horns in the connected vehicle. The bottom edge 114 of the body 106 has a recharging port 146 for recharging the integrated battery of the key fob 100. In different embodiments, the recharging port 146 can be one of USB port, mini-USB port, micro-USB port, type C-charger and any other type of charging port known in the state of the art. The buttons 142, 144 also have peripheral LED 126 for illumination when any of the button is pressed or activated by the user.

The body 106 can be made of plastic such as Acrylonitrile Butadiene Styrene or polycarbonate and can also be made of a composite material or a metal. The torsional spring 132 can be made of steel such as stainless steel or mild steel and can also be made of music wire or bronze. In different embodiments of the present inventions, the buttons 122, 124, 142, 144 of the key fob device 100 can be haptic buttons, capacitive buttons, tactile buttons, and similar.

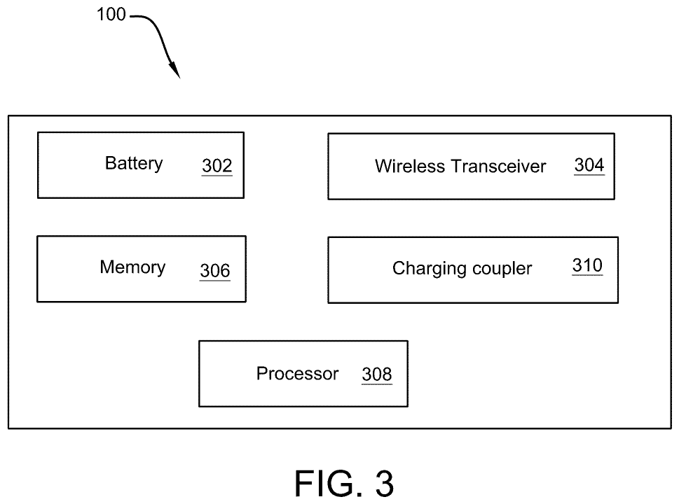

FIG. 3 illustrates a block diagram showing electronic components included in the rechargeable key fob of the present invention in accordance with the disclosed architecture. The key fob device 100 includes an integrated battery 302 for providing electrical power for functioning of the key fob 100 such as to operate the buttons, LEDs, and more. Preferably, the battery 302 is a Lithium-ion (Li-ion) battery and is configured to have high energy density, lightweight design, and rechargeable capabilities. The battery 302 can provide voltage in the range from 2 Volts to 4 Volts and can have a capacity in the range from 125 mA to 300 mA. It should be noted that the specifications of the Li-ion battery 302 can vary as per the key fob's power requirements and the charging capabilities of the USB port 146 integrated in the key fob 100.

A wireless transceiver 304 is included in the key fob 100 for providing a wireless channel for communication with a vehicle enabling a user to control the vehicle. The wireless transceiver 304 can be any of a radio frequency transceiver, NFC module, infrared transceiver, ultra-wideband transceiver and more. Different protocols including but not limited to Bluetooth, Zigbee, or proprietary protocols specifically designed for automotive applications can be used for establishing a wireless communication between the key fob device 100 and a vehicle.

An internal memory 306 is used for storing unique identification code or key code associated with a specific vehicle and firmware or software updates of the key fob 100. The stored code is used by the processor 308 to authenticate and authorize the key fob 100 for various vehicle functions, such as unlocking doors, starting the engine, or activating alarm systems. A charging coupler 310 couples the charging port 146 and the battery 302 and is configured to auto-cut or perform trickle charging to prevent overheating of the battery 302. The charging coupler 310 can be designed as per the type of the charging port 146 used in the key fob 100 and the battery capacity.

In some embodiments of the present invention, the peripheral LED lights 126 disposed around the buttons 122, 124, 142, 144 can illuminate in a first color for indicating low battery level of the key fob 100 for notifying users about low power level of the battery 302. In the preferred embodiment, the light 126 illuminates in red color when the power level of battery 302 is 10% or less of the total power level of the battery 302. In some embodiments, the light 126 can illuminate in a second color when the power level of battery 302 is 98% or more of the total power level of the battery 302 for indicating recharged battery level.

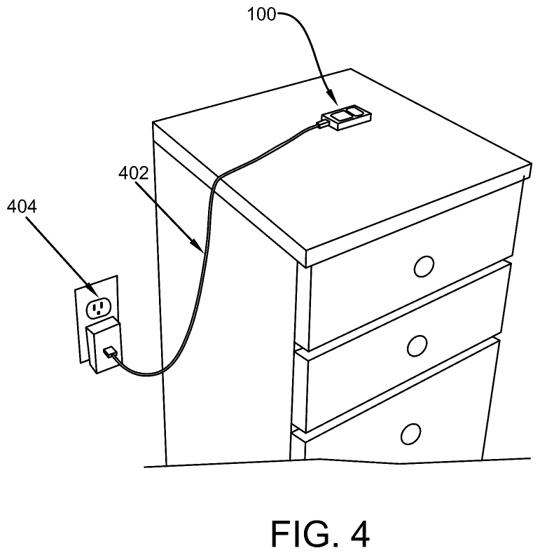

FIG. 4 illustrates a perspective view showing the rechargeable key fob connected to a charging cord for recharging integrated battery in accordance with the disclosed architecture. The charging port 146 of the key fob 100 can be used with a compatible charging cord 402 for recharging battery 302 of the key fob 100. This enables users to recharge the battery 302 and eliminates the need for battery replacements, thereby making the process of using and maintaining key fob 100 smoother and easier to use. The key fob 100 can be recharged by using the cord 402 with any wall mounted or other types of electrical sources 404.

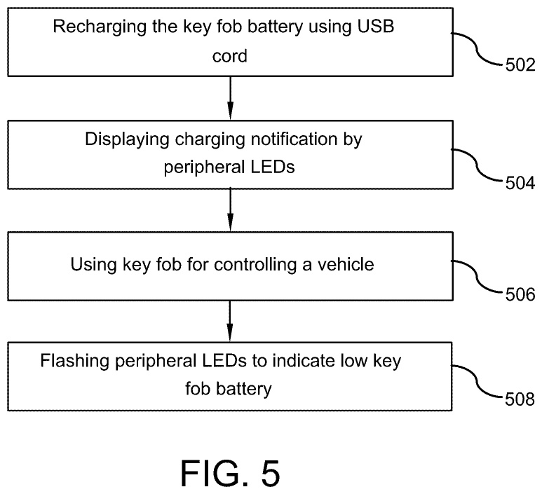

FIG. 5 illustrates a flow diagram depicting a process of using key fob and alerting a user of battery level in accordance with the disclosed architecture. Initially, the charging cord 402 is connected to the key fob 100 and a power source, such as a USB port or a wall adapter as illustrated in FIG. 4 for recharging battery 302 of the key fob (Step 502). When the key fob 100 is successfully connected to the charging cord 402 and charging begins, the peripheral LEDs 126 illuminate or blink in a specific pattern to indicate that the key fob is being charged and the illumination can change when the battery 302 is at least 98% recharged (Step 504).

Once the key fob battery 302 is charged and the key fob 100 is disconnected from the charging cord 402, the key fob 100 is used to control a vehicle (Step 506). The key fob 100 communicates wirelessly with the vehicle's onboard system to execute the commands. In some embodiments, the key fob 100 can be automatically disabled when it is being recharged using the charging cord 402. Finally, when the key fob battery is running low, the peripheral LEDs 126 can start flashing or illuminating in a specific pattern to indicate the low battery condition (Step 508).

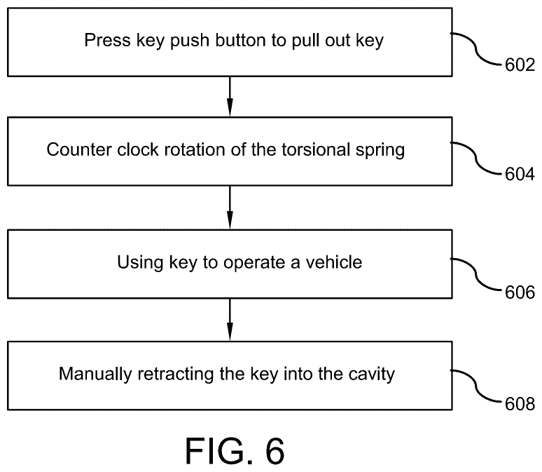

FIG. 6 illustrates a flow diagram depicting use of the key push button of the key fob device of the present invention in accordance with the disclosed architecture. Initially, for using the key 104, key push button 128 is pushed by a user (Step 602). In some embodiments, the push button 128 can be a touch button as well depending upon manufacturing of the key fob device 100. Upon pushing button 128, the torsional spring rotates counterclockwise to pull out the key from the cavity 102 along the side edge 118 and top edge 112 (Step 604). Then, the key 104 is used by the user for operating the vehicle (Step 606) and finally, the key 104 is manually retracted back to be stored in the cavity 102 (Step 608). Alternatively, the push button 128 is pushed again by the user to retract the key 104 back inside the cavity 102 for safe storage.

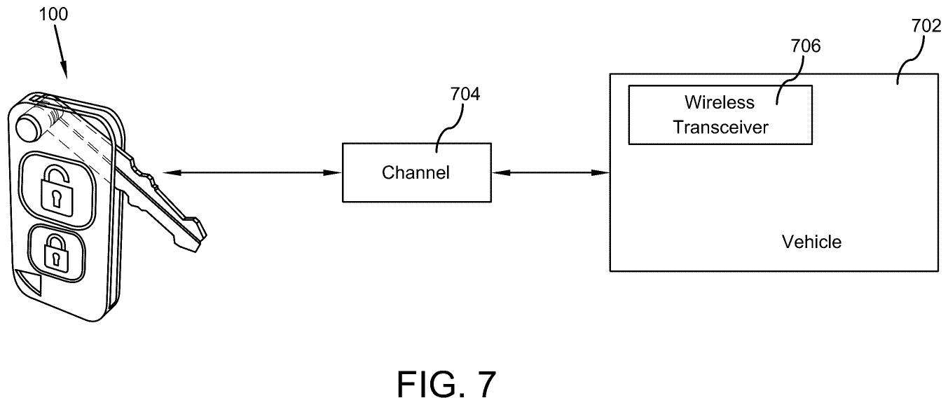

FIG. 7 illustrates a schematic view showing use of the rechargeable key fob device used for communication with a vehicle in accordance with the disclosed architecture. The key fob 100 can be used as a conventional key fob for communicating with the vehicle 702 for controlling operation of the vehicle 702 using different buttons as described in FIGS. 1 and 2. The communication is established using the wireless communication channel 704 between the wireless transceiver 304 of the key fob device 100 and wireless transceiver 706 of the vehicle 702.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “rechargeable key fob”, “key fob device”, and “vehicle key fob” are interchangeable and refer to the rechargeable vehicle key fob device 100 of the present invention.

Notwithstanding the forgoing, the rechargeable vehicle key fob device 100 of the present invention can be of any suitable size and configuration as is known in the art without affecting the overall concept of the invention, provided that it accomplishes the above stated objectives. One of ordinary skill in the art will appreciate that the rechargeable vehicle key fob device 100 as shown in the FIGS. are for illustrative purposes only, and that many other sizes and shapes of the rechargeable vehicle key fob device 100 are well within the scope of the present disclosure. Although the dimensions of the rechargeable vehicle key fob device 100 are important design parameters for user convenience, the rechargeable vehicle key fob device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A rechargeable key fob for accessing a connected vehicle, the rechargeable key fob comprising:
a key fob having a first panel, an opposing second panel, and a bottom edge;
wherein said first panel connected to said second panel along a first side edge and said bottom edge forming a cavity disposed between said first panel and said second panel;
wherein said key fob further having a rechargeable battery, a key, and a spring retained inside said cavity, and further wherein said key fob having a key push button accessible on an outer surface of said first panel;
wherein actuation of said key push button and said spring pivots said key from inside said cavity to outside said cavity along an opposing second side edge and a top edge;
wherein said cavity having a first width and said key fob having a second width;
wherein said first width from 75% to 80% of said second width;
wherein said outer surface of said first panel having a vehicle unlock button and a vehicle lock button;
wherein said vehicle unlock button having a first peripheral LED and said vehicle lock button having a second peripheral LED; and
further wherein said bottom edge having a recharging port for recharging said rechargeable battery.

2. The rechargeable key fob of claim 1, wherein said recharging port selected from a group consisting of a USB port, a mini-USB port, a micro-USB port, and a type C-charger port.

3. The rechargeable key fob of claim 1, wherein said spring is a rotating torsional spring positioned across said first panel and said second panel in said cavity.

4. The rechargeable key fob of claim 1, wherein said spring passes through a bow end of said key for rotating a blade portion of said key outside of said key fob.

5. The rechargeable key fob of claim 4, wherein said second panel having an outer surface including a rear liftgate unlock button for unlocking a rear liftgate and a Panic button for actuating a horn in the connected vehicle.

6. The rechargeable key fob of claim 5, wherein said vehicle unlock button, said vehicle lock button, said rear liftgate unlock button, and said panic button are selected from a group consisting of a haptic button, a capacitive button, and a tactile button.

7. The rechargeable key fob of claim 6, wherein said rechargeable battery provides electrical power for functioning of said key fob and said vehicle unlock button, said vehicle lock button, said rear liftgate unlock button, said panic button, said first peripheral LED, and said second peripheral LED.

8. The rechargeable key fob of claim 7, wherein said rechargeable battery is a Lithium-ion (Li-ion) battery including a voltage in the range from 2 Volts to 4 Volts and a capacity in the range from 125 mA to 300 mA.

9. The rechargeable key fob of claim 8, wherein said key fob having a wireless transceiver for providing a wireless channel for communication with the connected vehicle.

10. The rechargeable key fob of claim 9, wherein said wireless transceiver selected from a group consisting of a radio frequency transceiver, an NFC module transceiver, an infrared transceiver, and an ultra-wideband transceiver.

11. The rechargeable key fob of claim 10, wherein said key fob having a processor and an internal memory for storing a unique identification code associated with the connected vehicle to authenticate and authorize said vehicle unlock button, said vehicle lock button, said rear liftgate unlock button, and said panic button of the connected vehicle.

12. The rechargeable key fob of claim 7, wherein said first peripheral LED and said second peripheral LED illuminate in a first color for indicating low battery level of said key fob and illuminate in a second color for indicating high battery level.

13. The rechargeable key fob of claim 7, wherein said first peripheral LED and said second peripheral LED illuminate in a flashing pattern for indicating low battery level of said key fob.

14. A rechargeable key fob for accessing a connected vehicle, the rechargeable key fob comprising:
a key fob having a first panel, an opposing second panel, and a bottom edge;
wherein said first panel connected to said second panel along a first side edge and said bottom edge forming a cavity disposed between said first panel and said second panel;
wherein said key fob further having a rechargeable battery, a key, and a spring retained inside said cavity, and further wherein said key fob having a key push button accessible on an outer surface of said first panel;
wherein actuation of said key push button and said spring pivots said key from inside said cavity to outside said cavity along an opposing second side edge and a top edge;
wherein said outer surface of said first panel having a vehicle unlock button and a vehicle lock button;
wherein said vehicle unlock button having a first peripheral LED and said vehicle lock button having a second peripheral LED;
wherein said bottom edge having a recharging port for recharging said rechargeable battery;
wherein said second panel having an outer surface including a rear liftgate unlock button for unlocking a rear liftgate and a Panic button for actuating a horn in the connected vehicle;
wherein said vehicle unlock button, said vehicle lock button, said rear liftgate unlock button, and said panic button are selected from a group consisting of a haptic button, a capacitive button, and a tactile button; and
further wherein said rechargeable battery provides electrical power for functioning of said key fob and said vehicle unlock button, said vehicle lock button, said rear liftgate unlock button, said panic button, said first peripheral LED, and said second peripheral LED.

15. The rechargeable key fob of claim 14, wherein said spring is a rotating torsional spring positioned across said first panel and said second panel in said cavity.

16. The rechargeable key fob of claim 15, wherein said spring passes through a bow end of said key for rotating a blade portion of said key outside of said key fob.

17. The rechargeable key fob of claim 16, wherein said rechargeable battery is a Lithium-ion (Li-ion) battery including a voltage in the range from 2 Volts to 4 Volts and a capacity in the range from 125 mA to 300 mA.

18. A rechargeable key fob for accessing a connected vehicle, the rechargeable key fob comprising:
a key fob having a first panel, an opposing second panel, and a bottom edge;
wherein said first panel connected to said second panel along a first side edge and said bottom edge forming a cavity disposed between said first panel and said second panel;
wherein said key fob further having a wireless transceiver, a rechargeable battery, a key, and a spring retained inside said cavity, and further wherein said key fob having a key push button accessible on an outer surface of said first panel;
wherein actuation of said key push button and said spring pivots said key from inside said cavity to outside said cavity along an opposing second side edge and a top edge;
wherein said outer surface of said first panel having a vehicle unlock button and a vehicle lock button;
wherein said vehicle unlock button having a first peripheral LED and said vehicle lock button having a second peripheral LED;
wherein said bottom edge having a recharging port for recharging said rechargeable battery;
wherein said second panel having an outer surface including a rear liftgate unlock button for unlocking a rear liftgate and a Panic button for actuating a horn in the connected vehicle;
wherein said vehicle unlock button, said vehicle lock button, said rear liftgate unlock button, and said panic button are selected from a group consisting of a haptic button, a capacitive button, and a tactile button;
wherein said rechargeable battery provides electrical power for functioning of said key fob and said vehicle unlock button, said vehicle lock button, said rear liftgate unlock button, said panic button, said first peripheral LED, and said second peripheral LED;
wherein said wireless transceiver for providing a wireless channel for communication with the connected vehicle; and
further wherein said wireless transceiver selected from a group consisting of a radio frequency transceiver, an NFC module transceiver, an infrared transceiver, and an ultra-wideband transceiver.

19. The rechargeable key fob of claim 18, wherein said key fob having a processor and an internal memory for storing a unique identification code associated with the connected vehicle to authenticate and authorize said vehicle unlock button, said vehicle lock button, said rear liftgate unlock button, and said panic button of the connected vehicle.

20. The rechargeable key fob of claim 19, wherein said first peripheral LED and said second peripheral LED illuminate in a first color for indicating low battery level of said key fob and illuminate in a second color for indicating high battery level
